(19) United States
(12) Patent Application Publication
(10) Pub. No.: US 2007/0150140 A1
(43) Pub. Date: Jun. 28, 2007

(54) Incident alert and information gathering method and system

(76) Inventor: Shafer B. Seymour, Bartlett, IL (US)

Correspondence Address: MOTOROLA, INC., 1303 EAST ALGONQUIN ROAD, IL01/3RD, SCHAUMBURG, IL, 60196, US

(21) Appl. No.: 11/319,694

(22) Filed: Dec. 28, 2005

(51) Int. Cl. G06F 19/00

(52) U.S. Cl. 701/35; 340/438

(57) ABSTRACT

An apparatus, a system and a method of collecting vehicle data for use in incident investigations, including: a vehicle data recorder for recording vehicle parameters such as geographic location, speed, azimuth of motion, acceleration, brake pedal pressure and similar parameters: a means for detecting incidents such as an accident, and sending an incident message to a incident monitoring station, which then transmits a broadcast message. Other vehicles within communication range of the incident monitoring station each respond to the broadcast message with a report message including a unique identifier. When an incident occurs, a portion of the data stored prior to, and at the time of, the incident is saved for future retrieval. The incident message may be reported to a central site or other authority so that emergency response can be provided.

### TECHNICAL FIELD

This application relates to a method and system of vehicle telematics, and more particularly to the gathering of information regarding vehicles in or in proximity to an incident.

### BACKGROUND

The investigation of vehicular incidents and their causes would be facilitated by knowledge of the environment in which the incident occurred. Knowledge of the environment includes, but is not limited to, the position and motions of the vehicles involved, as well as vehicles which were in proximity to the incident but were not directly involved, or whose identity cannot be ascertained. Heretofore, the environment at the time of an incident may have been difficult to ascertain. The identity of the cars present, their positions, their speeds, and the actions taken by the drivers are all relevant to an incident investigation, both forensically and legally. Eyewitness accounts are often considered unreliable, and vehicles in proximity to the incident may have left the scene prior to the arrival of investigators. Lack of complete, reliable and factual information can hamper incident investigations.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 is a block diagram of vehicle-mounted components of a vehicular data collection system;

FIG. 2 illustrates the relationship between vehicles, a incident monitoring station and a central location in a vehicle data collection system;

FIG. 3 is a plan view illustrating the spatial relationship between vehicles and incident monitoring stations in the vicinity of an incident;

FIG. 4 illustrates a method of collecting data relating to vehicle operation, reporting incidents and storing vehicle data relating to incidents; and

FIG. 5 illustrates a method of responding to the receipt of an incident report message.

### DETAILED DESCRIPTION

Motor Vehicle Event Data Recorders (MVEDRs) collect, record, store and export data related to motor vehicle pre-defined events. Such data may be stored in proprietary data formats or conforming to voluntary industry standards, such as IEEE Std. 1616 “Motor Vehicle Event Data Recorders” (IEEE, Piscataway, NJ). IEEE Std. 1616 defines a protocol for MVEDR output data compatibility and export protocols of MVEDR data elements. The IEEE std 1616 does not prescribe which specific data elements shall be recorded, but instead provides a data dictionary of data attributes. The standard is applicable to event data recorders for all types of motor vehicles licensed to operate on public roadways, whether offered as original or aftermarket equipment, whether stand-alone or integrated into the vehicle.

IEEE P1616a, “Standard for Motor Vehicle Event Data Recorders (MVEDRs)—Amendment 1: Brake and Electronic Control Unit (ECU) Electronic Fault Code Data Elements,” which is being developed, requires units to store a history of time-stamped fault codes synchronized with other on-board MVEDR devices. As vehicles are outfitted with more electronic components, including communications, vehicle telematics and vehicle location systems, the accuracy and breadth of data which may be recorded on the state of a vehicle, and related to a time base, increases. Such data is likely to be recorded on a voluntary or mandatory basis in future.

The industry standards that have been described are only as examples of the types of data and the data formats which may be stored. Other non-standard or proprietary formats may be used as well, and the use of a specific format or data set is not necessary in the apparatus, systems and methods described herein.

The scope of the data that is recorded in a MVEDR or vehicle data recorder determines the specific utility of the data collected to an incident investigation, and may include time, vehicle speed, heading and location, acceleration and rotation, brake, accelerator and steering wheel operation, seat belt position, and the like, which may be characterized by sensors associated with the vehicle or with the vehicle data recorder. Incidents are not limited to accidents, but may encompass hard breaking, evasive or erratic maneuvers, or other driving actions as may be characterized by, for example, excessive yaw rates at a vehicle speed, and the like. Hard breaking may be characterized by a high deceleration as characterized by an accelerometer, while high yaw rate may be characterized by a gyroscope. Modem vehicles may have such devices already installed as part of systems as the automatic breaking system (ABS), or vehicle stability control. Such sensors may be used if suitable interfaces are provided in the vehicle, may be part of the data recorder, or may be external to the data recorder and interfaced with the data recorder. Other sensors, such as inclinometers, which may be used to detect vehicle upset (turnover), and global position system (GPS) receivers, which may be used to determine vehicle geographic location, are also useful, as well as information provided by vehicular navigation systems, when such systems are also installed. The data from any of these sensors may be used to determine that an incident has occurred, where the criteria for an incident is a matter of design or policy. The data from a sensor may be used directly or after analysis by the sensor, in the data recorder, or in another device. The resultant determination of whether an incident has occurred is, functionally, termed the incident detector output or result.

FIG. 1 illustrates a vehicle data recorder 10, such as a MVDER, having a memory 12 to store vehicle data 20 obtained from sensors and systems in the vehicle, which may include an incident detector 18, and which may have an incident memory 14 to store a portion of the recorded data. Alternatively, the incident memory 14 may be a designated area of the memory 12 and may be the same or different physical or logical memories and be the same or different memory technologies. Memory technologies which may be suitable for these functions include flash memory, random access memory (RAM), programmable read only memory (PROM), electrically erasable programmable read only memory (EEPROM), removable media, hard drives or other computer readable storage media. At least a portion of the memory may be non-volatile memory so as to preserve data in the event of an extended power loss. A microprocessor 24, or other computer as is known in the art, having a capability to read and execute stored software and firmware programs, manipulate data in one or more memory units, and interface with external devices is provided.

An incident detector 18 may provide a signal to the vehicle data recorder 10 when an incident such as an accident, air bag deployment or hard breaking occurs. The incident detector 18 may be one or more of other the vehicle systems or sensors, be integral to the vehicle data recorder, or be the result of analysis of other vehicle data by software in the processor of the vehicle data recorder 10. The incident detector 18 may be one or more of an accelerometer, an upset detector, such as an inclinometer to determine that the vehicle is no longer upright, a gyroscope to measure yaw rate, the speedometer or equivalent to measure speed, or other suitable sensor. The vehicle data recorder 10 may have sufficient memory 12 to store data for a length of time such that recording may take place continually from a time prior to the incident to a time after the incident. Providing that sufficient memory 12 is available, the time of the incident may not need to be identified until the data stored in the memory 10, 14 of vehicle data recorder 10 is read out. Alternatively, the data may be retained for a period of time and then overwritten in, for example, a circular data buffer maintained by software in the memory 12; the recording of data may be stopped at a time after the incident, thus preserving data representing the time prior to and during the incident. In another alternative, data for a period of time encompassing the time of an incident may be transferred to another memory location, the incident memory 14, or otherwise protected against being overwritten, where the memory 14 may be either a separate memory or be a logical or physical part of memory 12. Depending on the use of the incident reporting data, the data may be retained until read out by an authorized person, be retained for a specified time period, or maintained indefinitely.

The vehicle data recorder 10 is preferably installed in a vehicle 36 (a-n) as is shown in FIG. 2. Such a vehicle data recorder or “black box” may be powered from the vehicle electrical system, and may also have an internal power source such as a battery to facilitate recording during an incident when the electrical system may be damaged. The data may be recorded in memory 12, 14. Data and software programs may be stored in the non-volatile memory portion to preclude loss in the event of a power outage.

In an example, the system shown in FIG. 1 includes a MVEDR or similar “black box” data recorder 10, a communications device 16 which may be either integral to, or separate from, the data recorder 10, and an incident detector 18. The communications device 16 is in radio, audio or other wireless communications with an incident monitoring station 30, shown in FIG. 2. The communications device 16 transmits and receives messages in accordance with a communications protocol, including hardware and data protocols, and may encode the transmitted messages by modulating a carrier wave. The incident monitoring station 30 has a communications system 32 compatible with the communications device 16 the vehicle 36 and may be a cellular radio system, a system operating in accordance with a short-range wireless protocol such as IEEE 802.11a/b/g, or the dedicated short range communications system (DSRC), or the like. The DSRC is being jointly developed for vehicle safety and other mobile applications by the American Society of Testing and Materials (ASTM) and the Institute of Electrical and Electronics Engineers (IEEE). Communications may take place between the vehicle 36 and an incident monitoring station 30 or between two vehicles 36.

The incident monitoring station 30 also has a communications interface 34 to a central location 40, and may have a means for local data storage (not shown). The incident monitoring station 30 may be located at a known geographical location on either a permanent or temporary basis. In another aspect, the incident monitoring station 30 may be replaced by vehicle-mounted equipment having the same functionality as described for the incident monitoring station 30, and which communicates with the central location 40 using a communications means such as a cellular radio. In an aspect, the function of the incident monitoring station 30 may be performed by one or more vehicles located in the vicinity of the incident, such vehicles not being precluded from having their own vehicle data recorder, event detectors, position location devices and the like, or for sharing such capabilities with incident monitoring station functions. The use of the term “incident monitoring station” in this description shall be considered to encompass fixed, portable, mobile or vehicle-mounted equipment performing the functions thereof.

Detection of an incident by the incident detector 18 or by a comparable capability in the vehicle data recorder 10 initiates a communication protocol using communications means 16 in the vehicle with the incident monitoring station 30, having a compatible communications means 32, reporting an incident in an incident message. The incident message may include, but is not be limited to, the type of incident, the time of the incident, the location of the incident, and the like. Depending of the details of the system and method, some or all of this information may be transmitted from the incident monitoring station 30 to a central location or supervisory site 40 through a telecommunications interface 34, where the information received at the central location 40 may be used to initiate a response for appropriate services, such as police, fire, or ambulance.

Contemporaneously with reporting the incident message to the central location 40, the incident monitoring station 30 transmits a broadcast message to identify the vehicles 36 (b, . . . , n) in the vicinity of the vehicle 36a reporting the incident, and which are within communications range 46 of the incident monitoring station 30 (see FIG. 3). The broadcast message may also be termed a broadcast poll message or a poll message.

Alternatively, the transmission of the broadcast message by the incident monitoring station 30 may be in response to a broadcast request message received from the central location 40. The range of transmission 46 of the broadcast message from the incident monitoring station 30 is limited by the usual determinants of communications systems range, including transmitter power, antenna gain and height, operating frequency, data bandwidth, background radio noise, receiver sensitivity, and the like. In a known system, such as IEEE 802.11b, a maximum transmission distance of approximately 300 meters may be expected. In a situation where there is more than one incident monitoring station 30 in proximity to the incident, the incident reporting message from the vehicle 36a may be received by more than one incident monitoring station 30, and each incident monitoring station 30 may report the receipt of the incident reporting message to the central location 40. Each of the incident monitoring stations 30 receiving the incident reporting message may also transmit a broadcast message. Alternatively, the broadcast message may include an incident location and specify that vehicle capable of determining their location be within a set distance of the incident. Such a message may also permit vehicles not having a current ability to determine position, but being in communication with the incident monitoring station 30 to respond to the broadcast message.

Each vehicle 36 may be assigned a unique identification code ID, analogous to or being the vehicle identification number (VIN); however, the ID code may be different from the VIN. The correspondence between the VIN, which is unique to the vehicle, and the ID code which may be arbitrarily assigned, may be associated with the VIN or other owner data in a separate database.

Upon receipt of a broadcast message, a vehicle 36 may respond to the incident monitoring station 30 with a message containing the individual vehicle ID code. The IDs may be associated with VINs and vehicle ownership, and the owner of the vehicle 36 may be contacted so that the data in the MVEDR or similar vehicle data recorder 10 may be uploaded to an investigator computer or a data retrieval device 44. To the extent that the vehicle geographical position is also contained in the ID response message, the proximity of the vehicle to the incident at the time of the incident may also be used to perform a selection of the vehicle ID or VIN numbers which may be most pertinent to the incident investigation, thus optimizing the process.

In another aspect, when a vehicle has received a broadcast message, a segment of data representing a period of time prior to the receipt of the broadcast message, and which may extend to a period of time after the receipt of the broadcast message, may be transferred from the memory 12 to a separate memory 14, or otherwise protected or identified so that the data is not overwritten. For example, a 5 minute period prior to the event and a 2 minute period after the event may be selected. Provided that sufficient incident memory 14 capacity exists, data representing a number of incidents may be stored. The oldest stored incident data may be overwritten when memory is exhausted, or the latest event not stored as incident data, depending on the system design. Initiation of an incident by manual means may not overwrite the incident memory 14. This prevents a user from erasing the incident memory 14 by repeatedly actuating the manual incident report generating means. An example of a manual incident generating means is a “panic button”.

The vehicles 36 within communications range 46 of the incident monitoring station 30 respond to the broadcast or poll message with a response message giving at least the vehicle ID code or VIN number (see FIG. 2 and 3). The communications protocol may have a mechanism for randomizing the time delay between receipt of the broadcast message and the transmission of the ID code response message to avoid data collisions on the return path, or have some other transmission collision avoidance or resolution protocol to improve the probability that the response message is received by the incident monitoring station. The broadcast message may be transmitted multiple times to improve the probability of receipt at the vehicles. Other protocols, including handshaking protocols may be used, particularly for the response message.

The method of management of the message transmissions may include one of: randomizing the time delay between the receipt of a broadcast message and the transmission of a response by use of a parameter stored in each MVDER or vehicle data recorder, the generation of a random delay based on an aspect of the vehicle location (such as local latitude or longitude), a random delay based on computer clock time, or the like. The message transmission may be repeated multiple times with different delays so as to increase the chance of a valid reception of data from the vehicle at the incident monitoring station. Other communication protocols, including protocols in which the incident monitoring station acknowledges the receipt of a response message may be used. An alert may be displayed to a vehicle operator as an indication that an incident has occurred, and the vehicle operator may voluntarily contact the incident investigation authority.

Incident monitoring stations 30 may be disposed at locations in proximity to road areas in which frequent incidents occur, either on a temporary, permanent or mobile basis, or may be present in order to also serve other communications purposes. The central location 40, which may be any authority or service to which the incident monitoring station may transmit an incident report message may be located wherever the appropriate physical and communications capabilities exist.

FIG. 4 is a flow diagram illustrating an embodiment of a method of collecting vehicle data. The method 800 includes at block 810 storing vehicle data in a memory; at block 820 determining if one of an incident 830 has occurred or a broadcast message has been received at block 840; at block 850, storing a data portion including a period at least corresponding to a time prior to the event; at block 860, determining if the event is an incident or a broadcast message; at block 870, if the event is an incident, transmitting an incident message; at block 880, if the event is the receipt of a broadcast or poll message, transmitting a vehicle ID or report message.

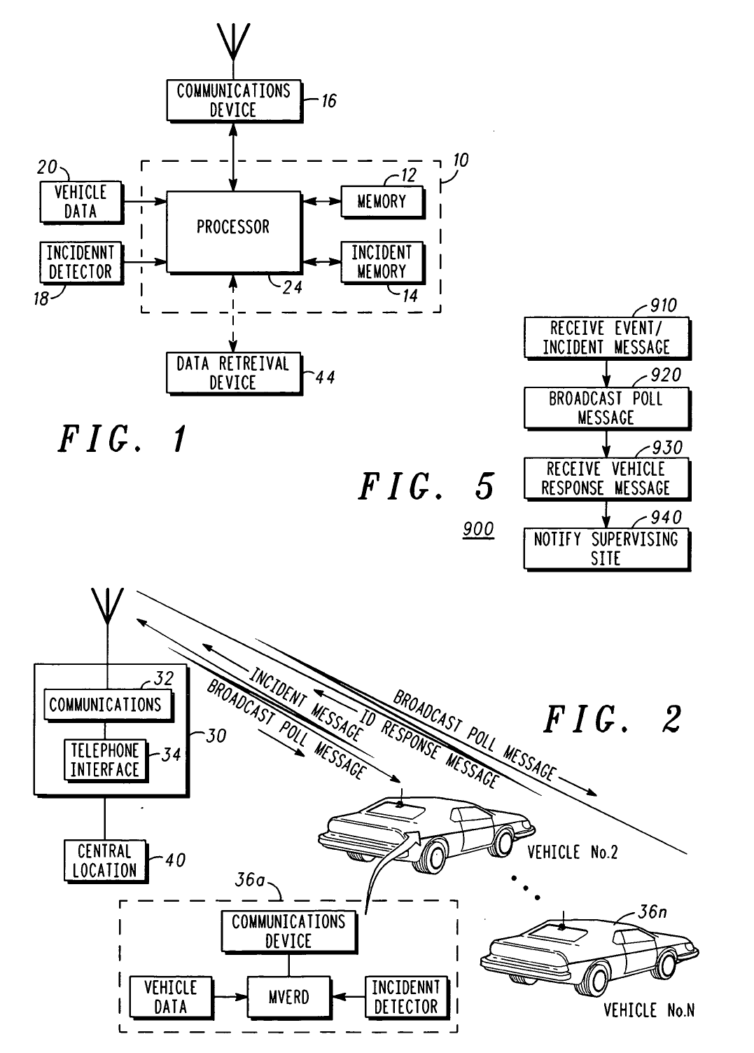

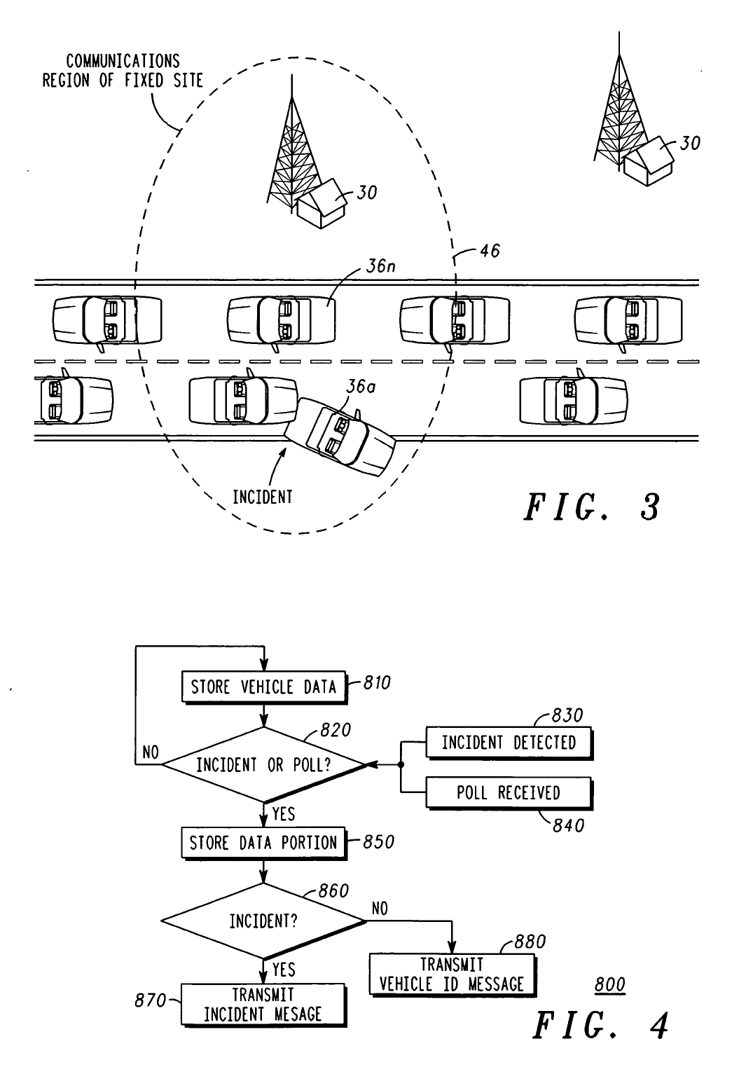

In another aspect, as illustrated in FIG. 5, a method 900 of collecting vehicle data includes, in one embodiment: at block 910, receiving an incident message at an incident monitoring station; at block 920, transmitting a broadcast or poll message; and at block 930, receiving a vehicle ID code response message including a vehicle ID. The method may further include: at block 940, reporting the incident message to the central site. In yet another aspect, the method may further include reporting the vehicle ID messages to the central site.

It is therefore intended that the foregoing description be regarded as illustrative rather than limiting, and that it be understood that it is the following claims, including all equivalents, that are intended to define the spirit and scope of this invention.

What is claimed is:

1. A data recorder for use in a vehicle, the data recorder comprising;
a processor;
a storage medium, an incident detector, and a communication device, each coupled to the processor;
wherein the storage medium comprises a first portion and a second portion, and at least the second portion is a non-volatile memory, data collected from a sensor being stored in the first portion; and data stored in the first portion being copied to the second portion when an event occurs, the event being one of an incident detector output representing an incident or a communication device output representing the receipt of a broadcast message.

2. The data recorder of claim 1, wherein an incident message is transmitted by the communications device in response to the incident or a vehicle report message is transmitted in response to the receipt of the broadcast message.

3. The data recorder of claim 2, wherein the incident message comprises a unique vehicle identification and, optionally, a vehicle location.

4. The data recorder of claim 2, wherein the vehicle report message comprises a unique vehicle identification and, optionally, a vehicle location.

5. The data recorder of claim 4, wherein the vehicle report message is not transmitted unless the vehicle is within a specified distance of a location contained in the incident message.

6. The data recorder of claim 1, wherein an incident comprises at least one of the following: air bag deployment, acceleration measured beyond a first threshold, deceleration measured beyond a second threshold, the vehicle being overturned, or evasive maneuvering of the vehicle.

7. The data recorder of claim 1, wherein the data stored in the second portion of the storage medium is retained for a predetermined period of time, retained until deleted by authorized personnel, or retained indefinitely.

8. The data recorder of claim 1, wherein the broadcast message is characterized by data modulated on a carrier wave by an incident monitoring station.

9. The data recorder of claim 1, wherein the incident message is characterized by data modulated on a carrier wave by the communications device.

10. The data recorder of claim 1, wherein the sensor comprises at least one of a vehicle navigation system, a global positioning system receiver, an accelerometer, an air bag deployment sensor, an inclinometer or a gyroscope.

11. The data recorder of claim 1, wherein the incident detector comprises at least one sensor.

12. The data recorder of claim 1, wherein the sensor is shared with other vehicle systems.

13. The data recorder of claim 1, wherein the communication device comprises a radio transmitter and a radio receiver.

14. An incident monitoring station, comprising:
a processor;
a storage medium and a communication device, each coupled to the processor; and
wherein the communication device receives an incident message from a data recorder in a first vehicle, and
wherein the processor, upon receipt of the incident message, causes the communication device to transmit a broadcast message, and
wherein the processor stores the incident message and a response to the broadcast message in the storage medium.

15. The incident monitoring station of claim 14, wherein the incident message comprises vehicle identification data unique to the first vehicle.

16. The incident monitoring station of claim 14, wherein the processor further causes a report of the incident message to be sent to another entity.

17. The incident monitoring station of claim 14, wherein a broadcast request message received from another entity causes the broadcast message to be transmitted by the communication device.

18. The incident reporting station of claim 14, wherein the broadcast message comprises location data and distance data, the distance data defining a distance from a location defined by the location data, and the data recorder installed in a second vehicle positioned within the distance from the location transmits a vehicle report message in response to the broadcast message.

19. The incident reporting station of claim 14, wherein the response to the broadcast message is a vehicle report message comprising at least vehicle identification data unique to the second vehicle.

20. The incident reporting station of claim 19, wherein the unique vehicle identification data is a vehicle identification number (VIN) for the second vehicle.
